(19) United States
(12) Patent Application Publication
(10) Pub. No.: US 2014/0001349 A1
(43) Pub. Date: Jan. 2, 2014

(54) OPTOELECTRONIC ROTARY ENCODER

(71) Applicant: Gerd Reime, Buhl (DE)

(72) Inventor: Gerd Reime, Buhl (DE)

(21) Appl. No.: 14/005,457

(22) PCT Filed: Mar. 14, 2012
(86) PCT No.: PCT/EP2012/001121

§ 371 Date: Sep. 16, 2013

(30) Foreign Application Priority Data
Mar. 17, 2011 (GB) 102011014374.2

(51) Int. Cl. G01D 5/347

(52) U.S. Cl. CPC G01D 5/3473
USPC 250/231.1

(57) ABSTRACT

An optoelectronic rotary encoder for setting or regulating parameters comprises a first measuring arrangement having a plurality of first light sources (2.41, 2.43), which are arranged on an imaginary closed line and emit light beams in a clocked manner, time-sequentially, and a first receiver (2.3) for receiving a first light beam emitted by at least one of the first light sources and reflected by an object. An evaluation device evaluates the light received by the receiver (2.3) and converted into electrical signals and determines therefrom a position of the object relative to the rotary encoder. A further measuring arrangement is provided for the identification of additional information likewise by means of the evaluation device. The further measuring arrangement has a further light source (2.5) and a further receiver (2.7) for receiving a further light beam emitted by the further light source (2.5) and reflected at the object. A shading element (2.2, 2.10, 2.11) permits the passage of the first light beams of the first measuring arrangement to and from a first location (1.3)—assigned to the imaginary closed line—of an operating surface (1.2) and passage of the further light beams of the further measuring arrangement to and from a further location (1.4) of the operating surface (1.2) in each case with reflection of the light beams into the receivers (2.3, 2.7). A simple and expedient rotary encoder is thus provided which can also be used in safety-relevant areas.

### CROSS REFERENCE TO RELATED APPLICATIONS

The present application claims the priority of German patent application 10 2011 014 374.2 which was filed on Mar. 17, 2011 and the published content of which is hereby expressly incorporated by reference in its entirety.

### TECHNICAL FIELD

The invention relates to an opto-electronic rotary encoder for setting or regulating parameters.

### BACKGROUND

A rotary encoder of this type is known from EP 1 435 509 B1 wherein three light sources in the form of LEDs are operated in turn, whereby two of the three light sources serving as transmitters radiate light along two light paths whilst the third light source is connected up as a receiver. Once a clock cycle has terminated in this arrangement, the receiver is again used as a transmitter in the next clock cycle whereupon one of the previous transmitters becomes the receiver, and so on. In the receiver, the incident light signals are converted into electrical signals which are then evaluated in order to detect the angular position of an object that is moving in a circle in front of the rotary encoder.

For evaluation purposes there, a measuring system known from EP 0 706 648 B1 is used wherein light sources alternately emit light in such a way that a constant light signal without clock synchronous alternating light components is present at a receiver. If, for example, two light sources and a receiver are provided, then an object located over the opto-electronic elements reflects light to the receiver. Thereby, the circuitry is set up in such a way that extraneous light has no effect and light signals which e.g. originate from the light paths extending between the light sources and the receiver can be clearly sensed. An optical transmission from a light source to a receiver is basically dependent on the position and the nature of the light-reflecting object. In the case of the principle known from EP 0 706 648 B1 however, the intensities of the two light sources are regulated in such a way that the receiver sees them with the same intensity. The ratio of the currents required for this purpose corresponds to the ratio of the optical transmissivity of the two paths. The regulation process always controls the working currents of the two light sources in opposing senses so that regulation of the received signals to zero occurs. The regulating signal is thus proportional to the ratio of one of the two optical transmission factors to the total transmission. Consequently, without knowledge of the transmission factors, it is possible to discern the equality thereof and thus the middle position of the object. This means that, independently of the type of object, a position that is equally spaced from the light sources can be reliably recognized.

From U.S. Pat. No. 5,103,085 A, a structure in an optical proximity detector is known wherein light channeled by a shading element is radiated outwardly through a glass layer. If an object such as a finger is located there, light is reflected back into the measuring device and the proximity thereof is evaluated.

From DE 103 00 223 B3, there is known an optical rotary encoder in which a plurality of light sources arranged along an imaginary circular line are operated alternately as receivers and light emitters. In parallel therewith, an extraneous light compensation process is effected by means of an independent light source which is associated with the receiver and the light intensity whereof is adjustable in amplitude and prefix sign. Shading is not envisaged.

From DE 100 24 156 A1, there is known a device for determining the position of an object in opto-electronic manner in which light is radiated alternately through a medium such as a sheet of glass from two emitters in the direction of a common receiver. The emitted, clocked signal is received by a common receiver and split into the components associated with the individual light sources. The receiver receives a reflection of the light beams at the glass plate on the one hand, and signals corresponding to the proximity of an object on the other, and these signals are evaluated in an evaluation unit. On the basis of the output value of the evaluation unit as well as a certain angular curve of the object vis a vis the radiation sources for known mutual spatial relationships of the radiation sources, the position and/or the movement of the object are detected.

From DE 10 2006 020 570 A1, there is known an opto-electronic device for detecting the position and/or movement of an object using a plurality of light emitters which develop a multidimensional light field. The movement of an object in the light field is detected. Moreover, the light beams can be deflected to a receiver by means of a bulge or a tactile snap dome. Thus, apart from the position detecting process, unambiguous operability of auxiliary functions is possible.

From EP 0 809 120 A2, there is known an optical position sensor in which two optical sensors with sensor-active regions are provided. The sensor-active regions of the sensors overlap so that the position can be determined by a process of determining an angular position within the entire sensor region in dependence on the received light.

A preferred area of application for rotary encoders may be that of entering PIN codes at e.g. cash-point dispensers in the sense of a dial provided with numbers. The security problems occurring up to now when inputting PIN codes are based on the fact that conventional 12 block keyboards are used and these are easily spied upon. The same applies in principle to an analogue dial. If, however, the dial could be formed in such a way that it is not provided with numbers, but rather, an arbitrary input position is recognized and commencing from there and by using a rotary motion a counter indicates the numbers zero to nine, then an increased level of security could thereby be achieved.

### BRIEF SUMMARY

Based upon this state of the art, the invention creates a simple and convenient rotary encoder which is also utilizable in security-critical areas.

On the one hand, the opto-electronic rotary encoder is capable of determining an angular position of an object based upon at least one light beam that is reflected by an object. In addition, a further measuring arrangement can also recognize further additional information such as a confirmation of a selected value for example. Both measuring arrangements are operated opto-electronically, i.e. by means of light sources and receivers. In order to obtain an unambiguous association, positions are provided on a control surface by means of at least one shading element at which it is possible for the light emitted by the light sources to pass through in such a way that it can be reflected and radiated back into the respective receiver. Just one quite specific signal which enables recognition of a maximum value of the reflection even from light sources being successively activated in turn can thereby be reliably evaluated. Upon movement of the object, displacement of the maximum value and its association with light sources that are known in regard to their location is also thereby recognized so that the direction of rotation of the object and also a relative rotational angle are determinable. From this, information can be determined which corresponds to the selection of a certain number of a PIN code for example. At the same time, additional information in the form of a confirmation of the selected numbers for example can be recognized by a further measuring arrangement.

Preferably, there is provided a plurality of groups of similarly connected light sources, preferably LEDs, which are arranged at the same angular spacing from each other and are operated in clocked manner by a clock pulse control system. In a sequentially effected evaluation process, it is possible to ascertain from the clock rate of the clock pulse control system as to which group of light sources is currently associable with a maximum value of radiated power being received at the receiver so that the position of the object such as an operator's hand on the control surface for example can be recognized. Commencing from here and upon further movement of the object, the further position relative to a previous position can then be determined thereby enabling the direction of rotation and the relative rotational angle to be determined.

Preferably, compensation light sources are used in the measuring arrangements. These compensation light sources are regulated by a device for regulating the intensity of the compensation light source and/or the first light source in such a way that the receiver registers both light entries, i.e. the light from the first light source and also the light originating from the compensation light source with the same intensity. The currents that have to be supplied to the first light source as well as the compensation light source for this purpose can be proportioned in order to obtain therefrom the desired information regarding the angular position or the actuation of the confirmation key.

Further advantages are apparent from the appending Claims and the following description of an exemplary embodiment.

### BRIEF DESCRIPTION OF THE FIGURES

The invention is described in more detail hereinafter with the aid of an exemplary embodiment. The Figures show:

FIG. 1 a perspective view of a control element,

FIG. 2 a cross section through the control element in accordance with FIG. 1.

FIG. 3 a plan view of the control element,

FIG. 4 the path of the light beams during actuation of the circular control element,

FIG. 5 regulating values R during actuation of the control element in accordance with FIG. 4.

FIG. 6 the path of the light beams during actuation of the central control element,

FIG. 7 a regulating value during actuation of the central control element,

FIG. 8 a block diagram for the operation of the control element,

FIG. 9 a timing diagram for the processing of the signals.

### DETAILED DESCRIPTION OF PREFERRED EXEMPLARY EMBODIMENTS

The invention will now be described exemplarily in more detail with reference to the accompanying drawings. Nevertheless, the exemplary embodiments are only examples which are not intended to limit the inventive concept to a certain arrangement. Before the invention is described in detail, it should be pointed out that it is not limited to the particular components of the device nor to the respective process steps since these components and methods can vary. The terms used here are only intended to describe special embodiments and are not used restrictively. In addition, if the singular or indefinite article is used in the description or in the Claims, this also relates to a plurality of these elements insofar as the general context does not make something else unambiguously clear.

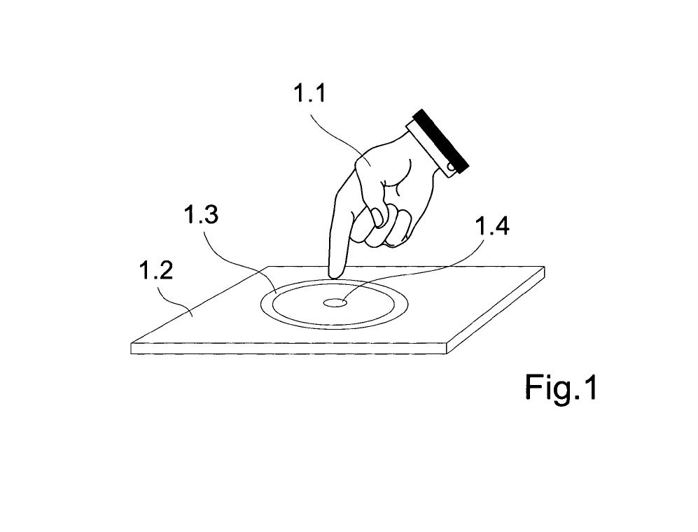

The Figures show an opto-electronic rotary encoder for setting or regulating parameters. A preferred area of application is e.g. the input of PIN Codes at cash-point dispensers for example. A solution of this type can be built into a cash-point dispenser e.g. in accordance with FIG. 1, i.e. on a closed line which in the exemplary embodiment has a circular shape, and located on a control surface 1.2 is a first location 1.3 that can be operated by an object 1.1 such as the operating hand in like manner to a dial of an analogue telephone. This first location 1.3 of the control surface 1.2 surrounds a central point-like further location 1.4 of the control surface. In operation, the hand can be guided along the first location 1.3 in a circle, whereby a first measuring arrangement associated with this first location detects the movement of the object and from this determines the position of the object relative to the rotary encoder and possibly also the direction of rotation or the rotational speed. Independently of the emplacement of the object on the first location 1.3 of the control surface 1.2 which corresponds to a recognized maximum reflection point, an e.g. counter for the numbers zero to nine can start there. If, during the rotary motion which is done intuitively like an analogue dial, a certain number is then reached by the user, he can confirm it at the further location 1.4 of the control surface 1.1 by an appropriate action. It is self-evident however that the rotary encoder can also be used for determining data other than PIN codes such as inputting coordinates or angular data to measuring instruments, machines or the like for example.

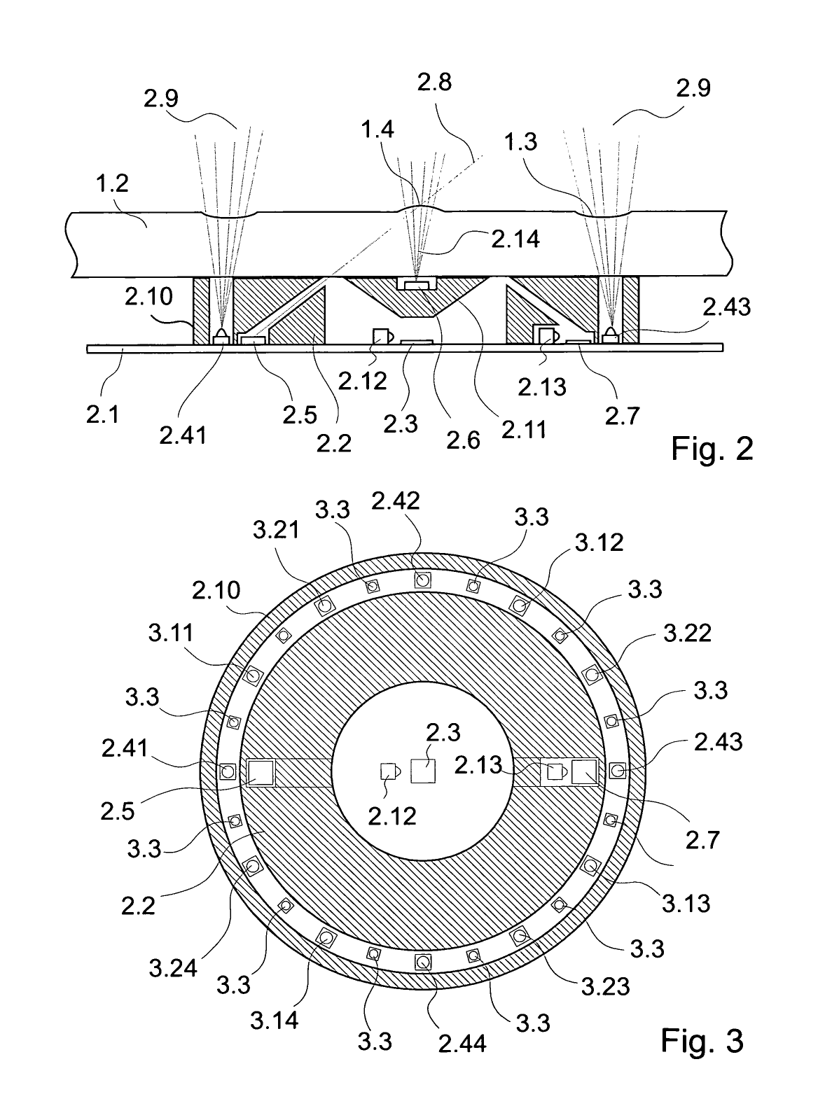

In regard to the arrangement of the opto-electronic rotary encoder, this is apparent from FIGS. 2 and 3. A first measuring arrangement comprises a plurality of first light sources 2.41, 2.42, 2.43, 2.44, 3.11, . . . 3.14, 3.21, . . . 3.24 which are located on an imaginary closed line. In the exemplary embodiment, these first light sources comprise a plurality of groups of similarly connected light sources, namely, the first group 2.41, 2.42, 2.43 and 2.44, the second group 3.11, 3.12, 3.13 and 3.14 and also the third group 3.21, 3.22, 3.23 and 3.24. It is self-evident that more or less groups could also be provided depending upon the desired resolution. LEDs are provided as background lighting 3.3 for this first measuring arrangement which is activated upon the approach of an object for example. Preferably, the further light sources can also be implemented as LEDs.

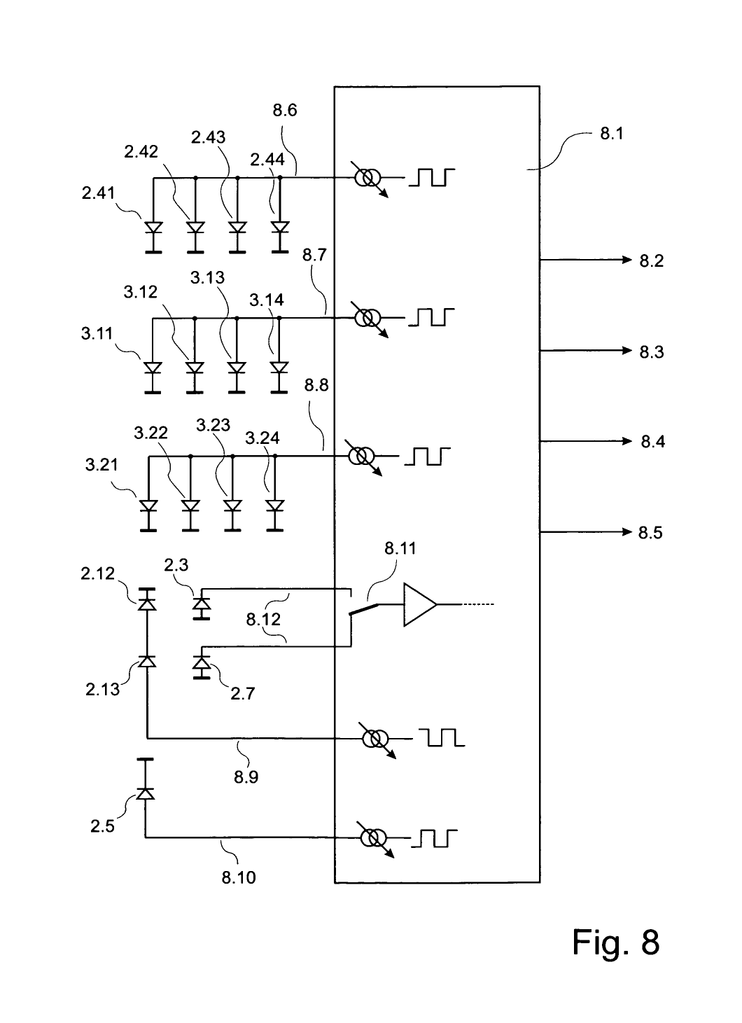

These first light sources emit light in clocked, time-sequential manner and, for this purpose, they are controlled by an IC in accordance with FIG. 8 (of the type 909.06 from Elmos Semiconductors AG for example), more details of which are given hereinafter. The first light sources are provided with at least one first receiver 2.3, in the form of a photodiode for example, there being exactly one receiver in the exemplary embodiment, for receiving a light beam that is emitted by at least one of the first light sources 2.41, 2.42, 2.43, 2.44, 3.11, . . . 3.14, 3.21 . . . 3.24 and is reflected by an object 1.1. A compensation light source 2.12 is associated with the receiver 2.3. An evaluation device 8.1 in the form of the IC is provided for evaluating the light beams converted by the receiver 2.3 into electrical signals and for determining a position of the object relative to the rotary encoder, whereby the angle of rotation, the direction of rotation and the rotational speed can also be determined from the position in conjunction with the known location of the first light sources and the elapsed time for the movement.

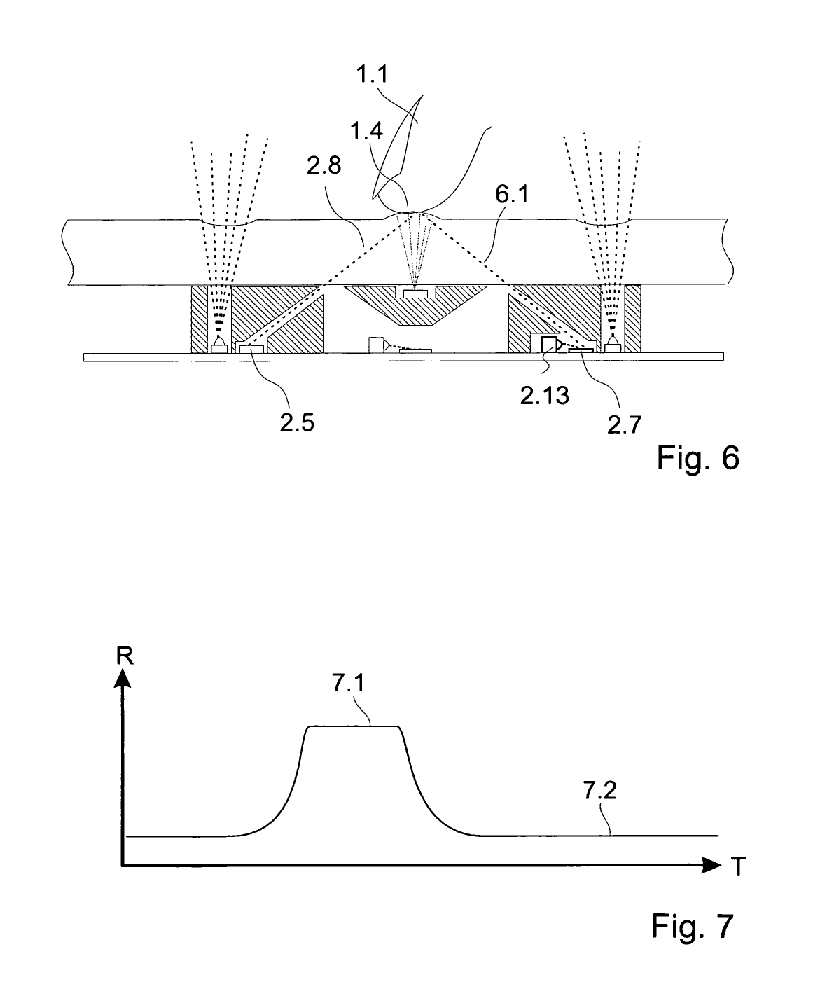

For the recognition of additional information, there is provided a further measuring arrangement which, in the exemplary embodiment, includes the output 8.4 of the confirmation key as additional information i.e. the confirmation of the selected number in the case of a PIN code. The further measuring arrangement comprises at least one further light source 2.5 and the at least one first receiver 2.3 or at least a further receiver 2.7 as the receiver, whereby exactly one further light source 2.5 and exactly one further receiver 2.7 are provided in each case in the exemplary embodiment. The receiver 2.7 which is likewise formed by a photodiode serves for receiving the further light beam emitted by the further light source 2.5 and reflected by an object 1.1 as is illustrated in FIG. 6. An LED serving as a further compensation light source 2.13 is likewise associated with the further receiver 2.7. In the absence of an object, the first light sources 2.41 or 2.43 radiate a light beam 2.9 upwardly through the control element 1.2 in accordance with FIG. 2. The further light source likewise radiates a light beam 2.8 in the direction of the further location 1.4 of the control surface 1.2. An LED 2.14 can be provided for illuminating the further location 1.4. Whilst the background lighting 3.3 and the LED 2.14 emit visible light, light in the non-visible region, in the infrared region for example, is preferably used for the first light sources 2.41, 2.42, 2.43, 2.44, 3.11, . . . 3.14, 3.21, . . . 3.24 and the further light source 2.5.

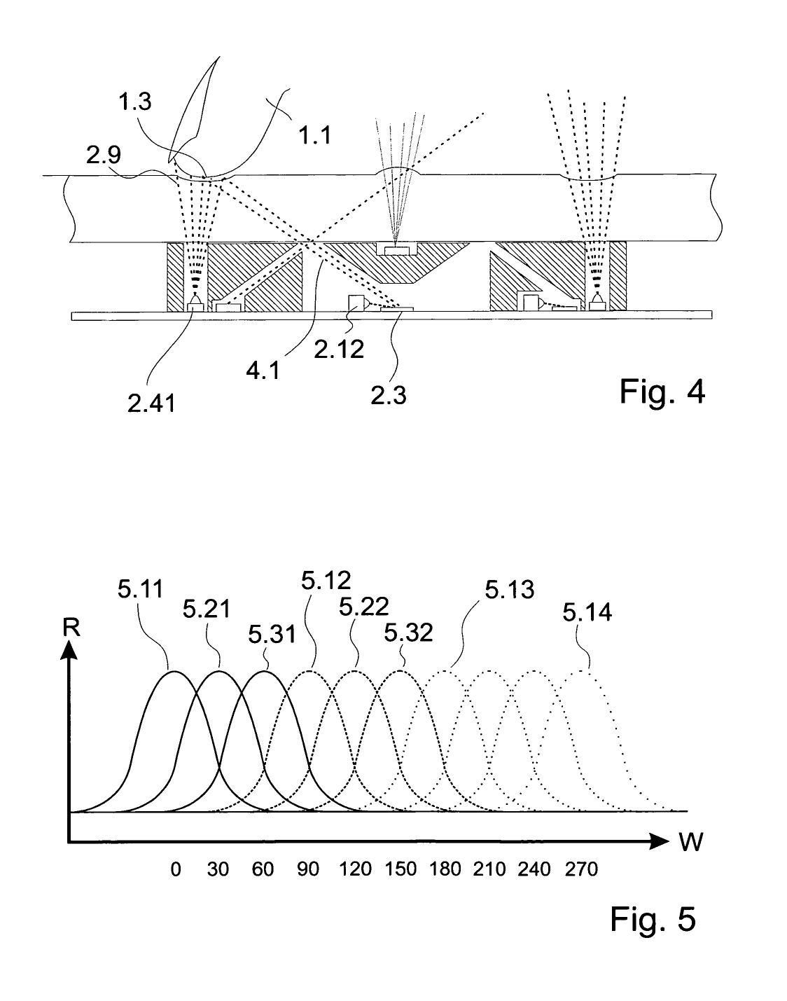

In order to recognize an increase or decrease in the reflection of the emitted light in the presence of an object 1.1, there is provided at least one shading element 2.2, 2.10, 2.11 which is preferably substantially rotationally symmetrical in the case of an imaginary circular closed line on which the first light sources 2.41, 2.42, 2.43, 2.44, 3.11, . . . 3.14, 3.21, . . . 3.24 are located, this then also leading in regular manner to a circular first location 1.3 in accordance with FIG. 1. In the first measuring arrangement in accordance with FIG. 4, the shading elements are suitable for permitting the passage of the light beams 2.9 from e.g. the first light source 2.41 through the through-openings arranged above the light sources to the first location 1.3 of the control surface 1.2. From there in the presence of an object 1.1, the light beam 4.1 reflected by the object passes through the appropriate through-opening to the first receiver 2.3. On the other hand, the shading elements permit the passage of the light beam 2.8 coming from the further light source 2.5 to the further location 1.4 of the control surface for the further measuring arrangement in accordance with FIG. 6. From there, in the presence of the object 1.1, light in the form of the light beam 6.1 reflected by the object passes in turn through the shading elements in the direction of the receiver 2.7. The through-openings are arranged through the shading elements in such a way that a reflection of the emitted light takes place in the region of the object 1.1 which is present.

FIG. 3 clarifies that the first light sources 2.41, 2.42, 2.43, 2.44, 3.11, . . . 3.14, 3.21, . . . 3.24 are also arranged at the same angular spacing from each other in the individual groups. These groups of light sources are clocked in time-sequential manner as is apparent from FIG. 8 for example. To this end in FIG. 8, the IC 8.1 has three outputs 8.6, 8.7 and 8.8 at the top on the left-hand side via which the groups of first light sources are controlled in clocked manner. The further light source 2.5 is also controlled at this clock rate via a fourth output 8.10 of the IC 8.1 depicted to the left at the bottom in FIG. 8. The compensation light sources 2.12 and 2.13 associated with the receivers 2.3 and 2.7 are also controlled in clocked manner via the compensation output 8.9. The first receiver 2.3 and possibly also the second receiver 2.7 which can be selected by an internal change-over switch 8.11 are connected to the input channels 8.12 of the IC 8.1.

The first and/or the further measuring arrangement comprise at least one compensation light source 2.12 and 2.13 which are respectively associated with the first receiver 2.3 and the further receiver 2.7 and emit light to the first and the further receiver.

In the IC 8.1, there is provided a device known from EP 0 706 648 B1 for regulating the intensity of the light which is emitted by the at least one first light source 2.41, 2.42, 2.43, 2.44, 3.11, . . . 3.14, 3.21, . . . 3.24 and arrives at the first receiver 2.3 and also the light emitted by the first compensation light source 2.12 that arrives at the first receiver 2.3 by means of a regulating value. The intensity of the light is regulated in such a way that the receiver 2.3 senses the at least one first light source and the first compensation light source 2.12 with the same intensity. At the same time, the evaluation device then uses this regulating value 5.11, . . . , 5.32 resulting in the sensing of the same intensity during the process of driving the sequentially operative light sources for detecting the position and/or the direction of rotation of the object 1.1 relative to the rotary encoder. Since, the light ratios alter for each movement of the object 1.1, there is a constant readjustment process taking place so that the position of the object can also be determined in time-dependent manner. The direction of rotation and also the relative angular position and, in conjunction with the time, the rotational speed along the circular first location 1.3 of the control panel 1.2 can be computed with the aid of the changing position. The confirmation by means of the further location 1.4 upon the approach of the object 1.1 and the subsequent removal of the object is likewise detected thereby.

For the purposes of amplifying the reflection, depressions and raised areas for assisting the reflection of the light beams depicted in FIG. 2 can be, but do not necessarily have to be, provided on the control surface 1.2 and arranged above the at least one shading element 2.2, 2.10, 2.11 at the first location 1.3 or at the further location 1.4.

Upon a movement of the object along the e.g. first location 1.3 of the control panel 1.2 which begins over the first light source 2.41 at the 9 o'clock position to the left in FIG. 3 and continues in the clockwise direction over the first light sources 3.11, 3.21, 2.42, 3.12, 3.22 etc., there results an image in accordance with FIG. 5. In FIG. 5, the angular position W is plotted along the abscissa and the regulating value R along the ordinate. If the object 1.1 approaches the first light source from the bottom left, the regulating value 5.11 appertaining to this first light source 2.41 gradually rises up to its maximum value which is set equal to the angular position 0 degrees in the exemplary embodiment. If the object is moved on over the further light sources, then this regulating value 5.11 drops back again, although the regulating value 5.21 for the neighboring first light source 3.11 then initially rises and, during continuation of the movement, the regulating value 5.31 for the further light source 5.21 and the regulating value 5.12 for the first light source 2.42 then rise successively whilst the previous one drops back again. However, as the position of the first light sources is known, a conclusion can thus be reached as to the position of the object in relation to the rotary encoder or relative to the position of maximum value at the first light source 2.41. The first impact of the object can then be defined by software as a zero-angular position, so that, when entering a PIN code, the further movement then successively gives rise in the control system to numbers which can be read off by the user at a suitable spot, for example within the location 1.3. From a computation of the position and the time, information can then be retrieved at the output channels of the IC 8.1 such as e.g. the direction of rotation at the output channel 8.2, the rotational increments at the output channel 8.3.

In principle, the further measuring arrangement in accordance with FIGS. 6 and 7 may be formed analogously to the first measuring arrangement. Here too, there is a compensation process by a device for regulating the intensity to the effect that the light emitted by the further light source 2.5 and reflected at the object 1.1 which is received and converted into electrical signals by the further receiver 2.7—or also by the first receiver 2.3 in a graphically not illustrated embodiment—is acquired there with the same intensity as the light that is being radiated by the further compensation light source 2.13 into the receiver. From this, there is likewise determined a regulating value which when plotted against time T during the approach of the object 1.1 has a waveform approximately as illustrated in FIG. 7. The regulating value 7.2 occurs when a finger has not been applied, but the regulating value 7.1 arises when the finger is applied so that an approach and an actuation of the further location 1.4 can be recognized reliably. From this waveform, the key actuation process is output at the output channel 8.4 and the approach of the object 1.1 at the output channel 8.5 of the IC 8.1.

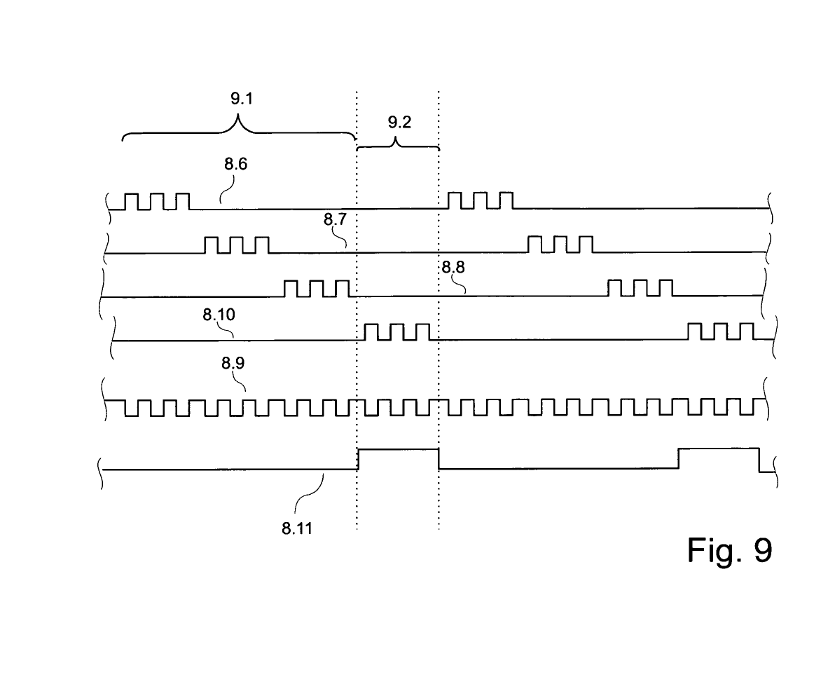

FIG. 9 shows the timing for the processing of the signals when the control panel is being used. For simplification, only a few clock pulses are illustrated in the Figures. In practice for example, about 40 clock pulse changes are used in each case. Hereby, a clock period comprises the process of switching the first light sources or the further light source into operation as well as an associated compensation clock rate in which the compensation light sources are switched into operation. In accordance with the timing for the compensation output 8.9, the compensation light sources are always controlled in breaks in the process of switching the light sources into operation. In accordance with FIG. 9, there are two time intervals 9.1 and 9.2. In the time interval 9.1, the three groups of first light sources 2.41, 2.42, 2.43, 2.44, 3.11, . . . 3.14, 3.21, . . . 3.24 are switched into operation successively via the outputs 8.6, 8.7 and 8.8, whereas the further measuring arrangement is inactive in this time interval, as results from the control process for the internal change-over switch 8.11. If the change-over switch 8.11 is actuated, the further time interval 9.2 starts by virtue of which the output 8.10 for the further light source 2.5 is now switched into operation so that the further location 1.4 of the control panel 1.2 is activated in this time period. Consequently, the relative angular position and also the rotary movement can be detected in the time interval 9.1, the actuation of the further location 1.4 in the center of the actuating field in the time interval 9.2.

It is self-evident that this description can be subjected to the most diverse of modifications, changes and adjustments which fall within the range of equivalents to the accompanying Claims.

1-8. (canceled)

9. An opto-electronic rotary encoder for setting or regulating parameters, comprising
a first measuring arrangement comprising
a plurality of first light sources which are located on an imaginary closed line and emit light beams in clocked, time-sequential manner,
at least one first receiver for receiving first light beams emitted by at least one of the first light sources and reflected by an object at a first location, associated with the imaginary closed line, on a control surface,
wherein an evaluation device is provided for evaluating a light received by the at least one first receiver and converted into electrical signals and for determining a position of the object relative to the rotary encoder,
and also comprising a further measuring arrangement for recognition of additional information likewise by means of the evaluation device, wherein the further measuring arrangement comprises at least one further light source and the at least one first receiver or at least one further receiver in each case for reception of further light beams emitted by the at least one further light source and reflected at the object at a further location on the control surface,
wherein there is provided at least one shading element comprising a plurality of separate through-openings bordered by the at least one shading element for a passage of the first light beams and for a passage of the further light beams to and from the first location into the first receiver or to and from the further location into the first receiver or into the further receiver.

10. A rotary encoder in accordance with claim 9, wherein the first location on the control surface surrounds the further location that is central and punctiform on the control surface in ring-like manner.

11. A rotary encoder in accordance with claim 9, wherein the first light sources comprise a plurality of groups of similarly connected light sources which are arranged on a circular line forming the closed line, wherein the light sources within a group are arranged at the same angular distance from each other and wherein the groups of similarly connected light sources are operated in clocked, time-sequential manner.

12. A rotary encoder in accordance with claim 9, wherein exactly one receiver is associated with the first light sources.

13. A rotary encoder in accordance with claim 9, wherein at least one of the first measuring arrangement or the further measuring arrangement comprises at least one compensation light source that is associated with the first receiver or the further receiver for emitting light to the first or the further receiver.

14. A rotary encoder in accordance with claim 13, wherein there is provided a device for regulating the light intensity of the light emitted by at least one first light source and arriving at the first receiver or of the light emitted by the at least one compensation light source and arriving at the first receiver by forming a regulating value in such a way that the first receiver senses the at least one first light source and the compensation light source with the same intensity, wherein the evaluation device evaluates the regulating value resulting in the sensing of the same intensity during the operation of the first light sources sequentially driven for ascertaining the angular position or the direction of rotation of the object relative to the rotary encoder.

15. A rotary encoder in accordance with claim 9, wherein the control surface arranged above the at least one shading element comprises depressions or elevations at at least one of the first location or of the further location for facilitating total reflection of the light beams.

16. A rotary encoder in accordance with claim 9, wherein computing means are provided which sense a maximum in reflection of the first light beams during approach of an object as a starting point and commencing therefrom, upon movement of the object and thus a maximum in the reflection along the imaginary line, determine a relative angular position to the starting point.
